(19) United States
(12) Patent Application Publication
(10) Pub. No.: US 2009/0152480 A1
(43) Pub. Date: Jun. 18, 2009

(54) FLUID BACKUP PREVENTING SYSTEM, AND METHOD OF USE THEREOF

(76) Inventor: Patrick Savaria, Longueuil (CA)

Correspondence Address: FRASER CLEMENS MARTIN & MILLER LLC, 28366 KENSINGTON LANE, PERRYSBURG, OH, 43551, US

(21) Appl. No.: 11/955,990

(22) Filed: Dec. 13, 2007

(51) Int. Cl. F16K 31/126

(52) U.S. Cl. 251/12

(57) ABSTRACT

An apparatus for continuously controlling fluid flow in a sewer conduit, comprising: a) moisture sensors detecting levels of fluid in this conduit; b) an inflatable bladder, mounted in the sewer conduit for releasably sealing in fluid tight fashion a section of this conduit; an air compressor, for inflating the bladder; and a control box including a CPU, sensitive to the moisture sensor and actuating the air compressor responsively to conduit fluid level conditions reaching beyond a preset threshold value. The performance of the apparatus is independent of the speed of fluid flow in the sewer conduit.

### FIELD OF THE INVENTION

The present invention relates to the field of fluid flow control systems concerned with a fluid backup preventing system for sewer ducts and the like.

### BACKGROUND OF THE INVENTION

There exists a plurality of situations wherein it is desirable to control accidental fluid backup flow in specific circumstances.

In a building or other structures serviced via an underground sewer line, it sometimes occurs that the main sewer line or the branch line leading from the building to the main sewer line becomes clogged. Indeed, the problem of basement flooding from sewer line water backup flow has become prevalent in recent years. The backup may be caused by a variety of problems including when the flow capacity of the sewer system is exceeded by the rain water inflow rate into the system.

The risk of water backup is present in most storm sewer systems where the storm sewers are rarely of a sufficient size to accommodate unusually heavy rain storms. This risk is sometimes present in sanitary sewer system where there is a water leakage into the sewer system through manholes, cracks in sewer line joints or where improper roof down spout connections are made to the system which normally should carry only the water and sewage draining from sinks, toilets, washing machines drain lines and basement floor drains.

Clogging of the sewer line may be caused by many factors including broken or misaligned pipes. Such broken or misaligned pipes present projections, ridges or sharp bends on which bulk material hangs up and causes a nucleus fore clogging. Other times, roots from surface plants invade the pipe in search of moisture which may be leaking from poorly formed joints in the pipe and these roots also can form the nucleus of the clog in the pipe. Whatever the cause of the clog, the effect is that the sewage becomes backed up in the line and eventually the backflow will overflow from the fixtures and drains in the building.

Modern sewer systems are equipped with clean out pipes or outlets. The clean out is accomplished by inserting a Tee or Y joint in the sewer line just outside the building or in the basement. Leading from the Tee or Y joint is a vertical or near vertical clean out pipe which is kept or plugged near the ground surface. While this type of clean out allows for access to the sewer line for removal of clog, it does not prevent the backflow or sewage through the sewer line which will eventually overflow from the fixtures or drain inside of the building.

Backup problem in sanitary sewer lines leading to an individual home can be substantially eliminated by the application of a backflow preventing valve in the pipe line extending between the home and the underground sanitary sewer line running along the street involved. When backup water pressure builds up, the backflow preventing valve is closed or closes to prevent the water in sanitary sewer lines from backing up into the user's home.

However, many home owners simply do not wish to incur such systems. Indeed, conventional flow protection usually consists of a simple check valve, more particularly a flap valve mounted inside the sewer duct, which functions as a pivotable gate providing for unidirectional flow of the fluid in the sewer line away from the source. However, these pivotal gates are only efficient when the fluid flow inside the sewer is at fast speed, since the gate will then be forcibly pivotally biased against its annular seat inside the sewer duct by the hydrodynamic forces. Such pivotal gate valve systems are however ineffective in conditions of sewer duct clogging, since the fluid level inside the sewer duct raises quite progressively, and the fluid flow speed is usually small, which would not provide a hydrodynamic force suitable for pivotally biasing the pivotal gate against its annular seat in a fluid tight fashion.

Inflatable bladders may be used in place of pivotal gate valves, although these bladders create a phenomenon of fluid flow turbulence. When these bladders are in their inoperative deflated condition, they remain in a radially inwardly projecting condition inside the sewer duct passage that constitutes a partially obstructive element.

Furthermore, most conventional fluid backflow mitigating prior art systems are not efficient in early detection of fluid and thus are relatively unreliable and inefficient.

### SUMMARY OF THE INVENTION

Accordingly, there exists a need for an improved fluid backup preventing system that can be used in a variety of situations such as in sewer lines to prevent sewer backup into basements.

In accordance with the teachings of the invention, there is disclosed an apparatus for continuously controlling fluid flow in a conduit, comprising: a) sensor means, for detecting the level of fluid in this conduit; b) conduit sealing means, for releasably sealing in fluid tight fashion a section of this conduit; c) main power means, for actuating said sealing means; and d) control means, sensitive to said sensors means and actuating said main power means responsively to a conduit fluid level reaching beyond a threshold value; wherein the performance of said control means is independent of the speed of the fluid flow in the conduit.

Preferably, said control means are further sensitive to the deactivation of said main power means, and further including power backup means, whereupon said control means automatically activating said conduit sealing means independently of fluid level in the conduit when said main power means becomes deactivated. Said control means preferably further includes a self test function for the power backup means that checks at predefined regular time intervals if said conduit sealing means is operative, and further including alarm means (sound, light or otherwise) issuing an alarm detectable by the apparatus user upon said control means detecting that said power backup means has become inoperative.

Preferably also, said conduit sealing means includes an inflatable bladder for mounting into the conduit section, and further including inflating means for inflating the bladder between a deflated inoperative condition and an operative inflated condition for sealingly closing the conduit section. Said inflatable bladder could then have in its operative inflated condition a portion of toroidal shape for sealingly engaging the conduit section. Said bladder could be elongated with two opposite end portions each forming a convex half sphere. Said sensors means could include at least one pair (preferably two pairs) of positive and negative electrical cables, said cables extending between said control means and said bladder, and moisture sensors mounted at the end of said cables located about said bladder. Said moisture sensors are preferably covered by non corrodible fluid proof conducting alloys, and uses electrical conductivity measures for determining the fluid level in the conduit.

The invention also relates to a method for operating an apparatus for continuously controlling fluid flow in a conduit, the apparatus of the type comprising sensor means for detecting levels of fluid in this conduit, conduit sealing means for releasably sealing in fluid tight fashion a section of this conduit, main power means for actuating said sealing means, and control means, sensitive to said sensors means and actuating said main power means responsively to a conduit fluid level reaching beyond a threshold value so that the performance of said control means is independent of the speed of the fluid flow in the conduit; wherein the method comprises the following steps:

a) said sensor means sensing a fluid level beyond said threshold value;

b) said control means analysing data coming from the sensors means; and

c) said control means actuating said conduit sealing means responsively to said data.

Preferably, there is further included the following steps:

d) having said sensor means detecting fluid level returning to condition short of said threshold level;

e) said control means analysing this latter data from said sensors means; and

f) said control means deactuating said main power means responsively to the latter data.

The invention also relates to the combination of sewer conduit for fitting to a dwelling, said conduit having a clean-out duct mounted transversely thereto and opening into said fluid flow channel, and the above-noted apparatus.

The invention also relates to a method for installing and releasably locking a valve apparatus inside a clean-out duct of a sewer conduit, the valve apparatus for continuously controlling fluid flow in the conduit, the apparatus including: a) sensor means, for detecting the level of fluid in this conduit; b) conduit sealing means, for releasably sealing in fluid tight fashion a section of this conduit; c) main power means, for actuating said sealing means; and d) control means, sensitive to said sensors means and actuating said main power means responsively to a conduit fluid level reaching beyond a threshold value; wherein the performance of said control means is independent of the speed of the fluid flow in the conduit, the apparatus further including a discoid support member releasably mounted inside the clean-out duct, a hang screw rod assisting in the positioning of said discoid support system in said clean-out duct, said sealing means being an inflatable bladder, said inflatable bladder in deflated configuration movable to a set position inside the clean-out duct, and further including retaining clips to prevent accidental release of said apparatus from its said set position, wherein said method comprises the following steps: a) said hang screw rod moving the said apparatus inside said clean-out duct; and b) said inflatable bladder in deflated configuration emitting a sound cue emitted through said rod, indicating said deflated bladder has reached its said set position inside the clean-out duct.

Preferably, said sensor means could then include power cables and, upon release of said valve apparatus being required, further including the following step: c) pulling out said apparatus from said fixed position in said clean-out duct, by upwardly pulling said power cables.

Preferably, said clean-out duct defines an annular recess fully clearing said channel, said conduit sealing means including an inflatable bladder mounted into said annular recess, and inflating means for inflating the bladder, said bladder when in an inoperative condition remaining fully inside said annular recess and fully clearing said channel to prevent fluid flow turbulence in the conduit when deflated, and when in an operative inflated condition further extending radially into said channel and fully sealingly closing said channel.

The present invention therefore provides a system for blocking fluid flow within a conduit and utilizing an inflatable component which is located permanently in the conduit or a section that allows access to the conduit wanted to protect from fluid flow backup. An electrical moisture sensor capable of rapidly and accurately detecting the fluctuation of fluid in a conduct and transmitting the information to the circuitry forms part of the invention.

A circuitry receives the information from the moisture sensors and then decides whether or not it will activate the inflatable component to prevent fluid backup.

A backup battery of the circuitry is also provided, in case of electrical mains supply blackout, so as to enable relying on backup battery that will automatically activate the inflatable component by default, independently of fluid level inside the sewer conduit.

### BRIEF DESCRIPTION OF THE DRAWINGS

FIG. 1: is a longitudinal sectional view of an intermediate section of sewer conduit, showing a fluid backup preventing system in accordance with an embodiment of the present invention mounted on a transverse clean-out duct into the sewer conduit, the inflatable bladder being shown in a retracted deflated inoperative position inside the clean-out duct;

FIG. 2: is a view similar to FIG. 1, but with the inflatable bladder being inflated in a fully inflated operative configuration, extending radially into the sewer conduit and fully closing a section of the latter;

FIG. 3: is a partly schematic enlarged plan view of the control box of a fluid backup preventing system in accordance with an embodiment of the present invention;

FIG. 4: is a partial plan view of a control panel part of a fluid backup preventing system in accordance with an embodiment of the present invention;

FIG. 5: is a partial enlarged perspective view of a pneumatic tube and electrical wire assembly from the fluid backup preventing system in accordance with an embodiment of the present invention;

FIG. 6: is an enlarged view of the area circumscribed by ellipse 6 in FIG. 5;

FIG. 7 and 8: are partial elevated views of the inflatable bladder, suggesting the adjustable nature of cable sleeve connection between electrical circuits and the inflatable bladder of the fluid backup preventing system in accordance with the present invention;

FIG. 9: is a partial perspective view of the inflatable bladder, showing in phantom lines the fluid sensor part inside the bladder of a fluid backup preventing system in accordance with an embodiment of the present invention;

FIG. 10: is a enlarged cross-sectional view taken along lines 10-10 of FIG. 1, showing how the inflatable bladder clears the sewer conduit in the retracted inoperative condition thereof in accordance with the present invention;

FIG. 11: is a partly broken perspective view of the sewer duct, showing the inflatable bladder in its operative fully inflated condition, similarly as in FIG. 2;

FIG. 12: is an enlarged cross-sectional view of the discoid support system installed in the clean-out duct taken along line 25-25 of FIG. 1, in accordance with an embodiment of the present invention; and

FIG. 13: is an enlarged longitudinal sectional view of an intermediate section of the clean-out duct, showing the discoid support system from FIG. 12 installed therein, the inflatable bladder being shown in a retracted deflated inoperative position inside the clean-out duct.

### DETAILED DESCRIPTION OF THE INVENTION

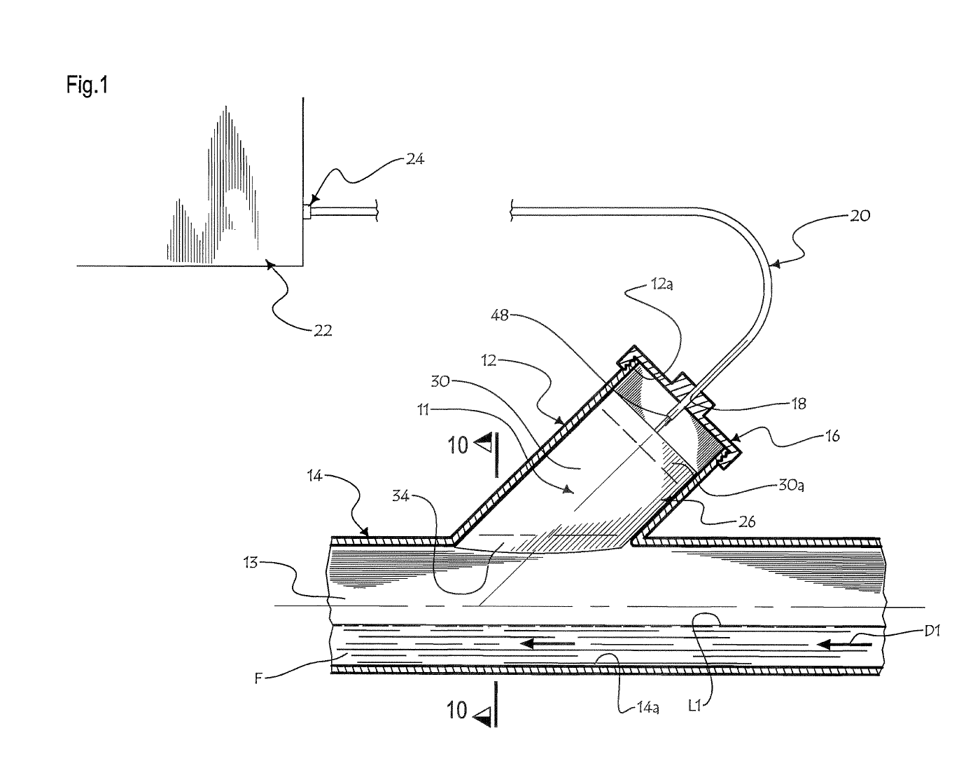

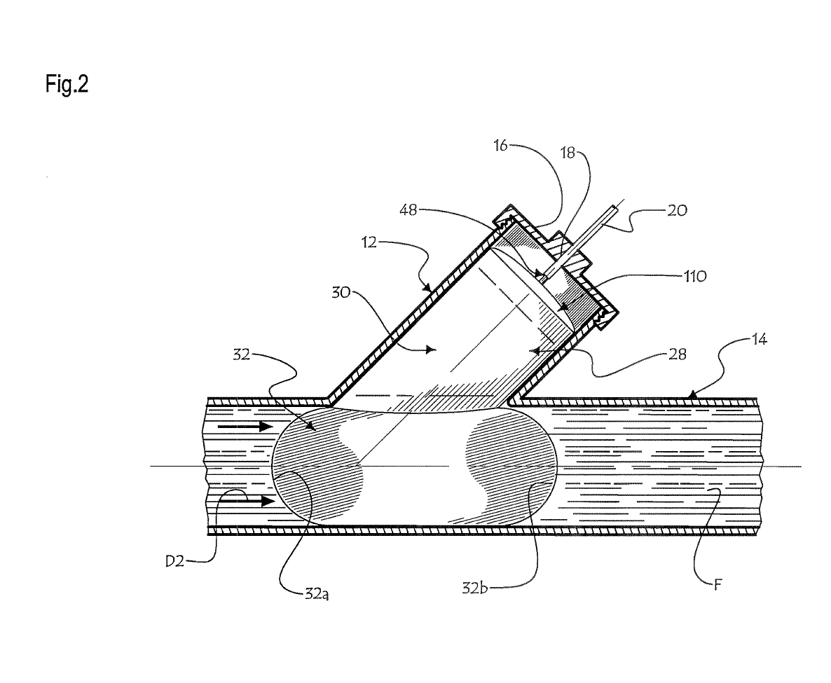

Referring to FIGS. 1 and 2, there is shown a fluid backup preventing system 11 in accordance with an embodiment of the present invention mounted into a clean-out duct 12 transversely opening into the channel 13 of sewer conduit 14. A fluid F, for example a liquid, may flow inside channel 3 at a low fluid level L1, along a normal flow direction D1.

The clean-out duct 12 is preferably provided with a distal threaded segment 12a so as to threadingly receive a mounting cap 16 provided with a cap aperture 18 extending centrally there through. The cap aperture 18 is configured and sized so as to fittingly receive at an intermediate section of a cable sleeve 20 for protectively enclosing various operative cables (pneumatic line 36 and electrical wires 43, 43′, 43″, 43′″) hereinafter disclosed and also for supporting the valve components in a suitable overlying relationship relative to the sewer conduit 14.

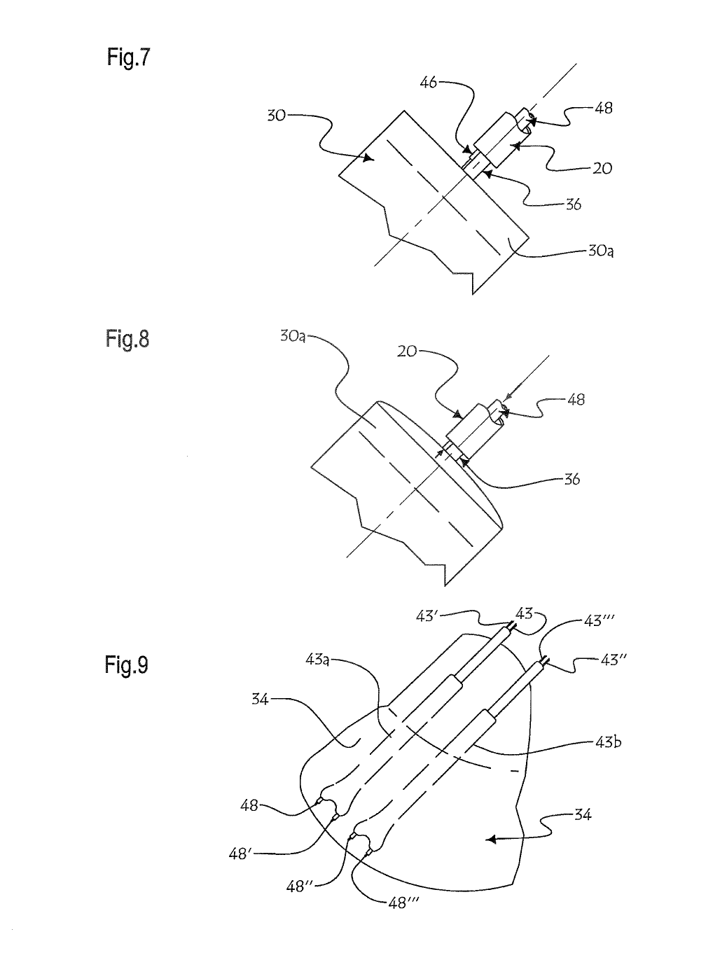

As mentioned previously, it should be understood that although the fluid backup preventing system is shown in FIGS. 1 through 11 and hereinafter disclosed is being used in the context of sewer conduits, it could also be used in various other contexts without departing from the scope of the present invention.

The sleeve 20 is connected at a proximal end portion thereof to a casing 22 by a suitable connecting ring 24 and at a distal end thereof to a valve means 26. The valve means 26 preferably takes the form of an inflatable component, typically an inflatable bladder 30 at least partially mounted within a bladder sleeve 28. Bladder 30 is mounted inside clean-out duct 12. The bladder 30 is adapted to be inflated to an inflated configuration illustrated in FIGS. 2 and 11 wherein its inflated flow obstricting section 32 projects radially inwardly of channel 13 and abuttingly fully contacts the interior wall 14A of the duct 14 in fluid tight fashion so as to prevent accidental backflow into the latter when fluid overflow conditions are met. That is to say, fluid flow direction D2 (FIG. 2) is prevented, being a reversal of the direction of original normal fluid flow direction D1 (FIG. 1), which is associated with a fluid overflow condition of fluid F inside sewer duct 14 (FIG. 2).

The bladder 30 further includes a distal contacting portion 34 located opposite its flow obstructing portion 32, which is adapted to inflate to a contacting configuration also shown in FIG. 2 when the pre-set fluid overflow condition is met.

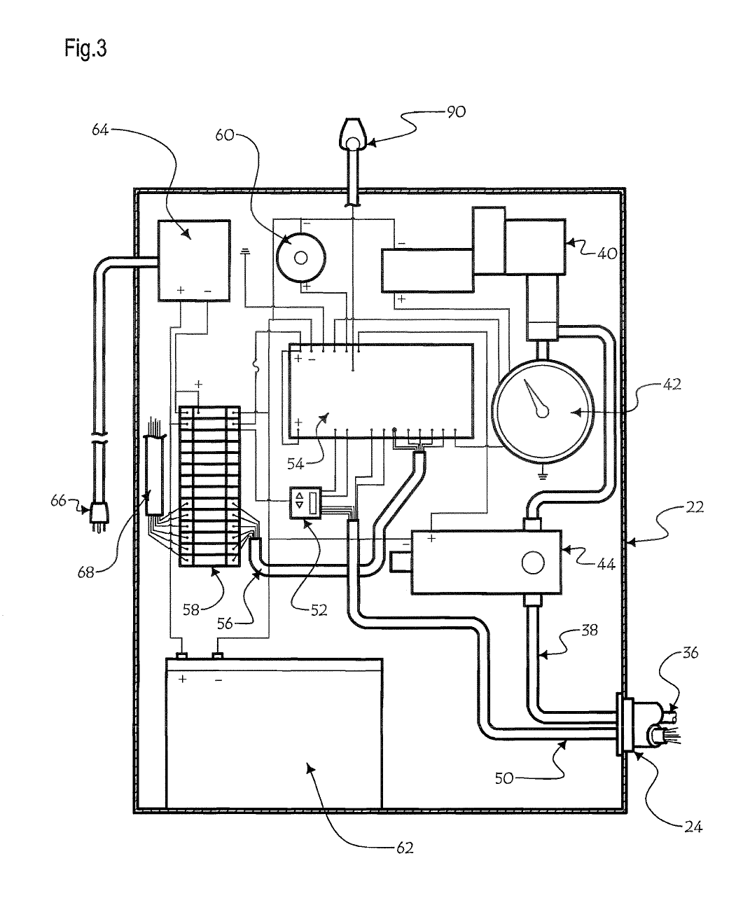

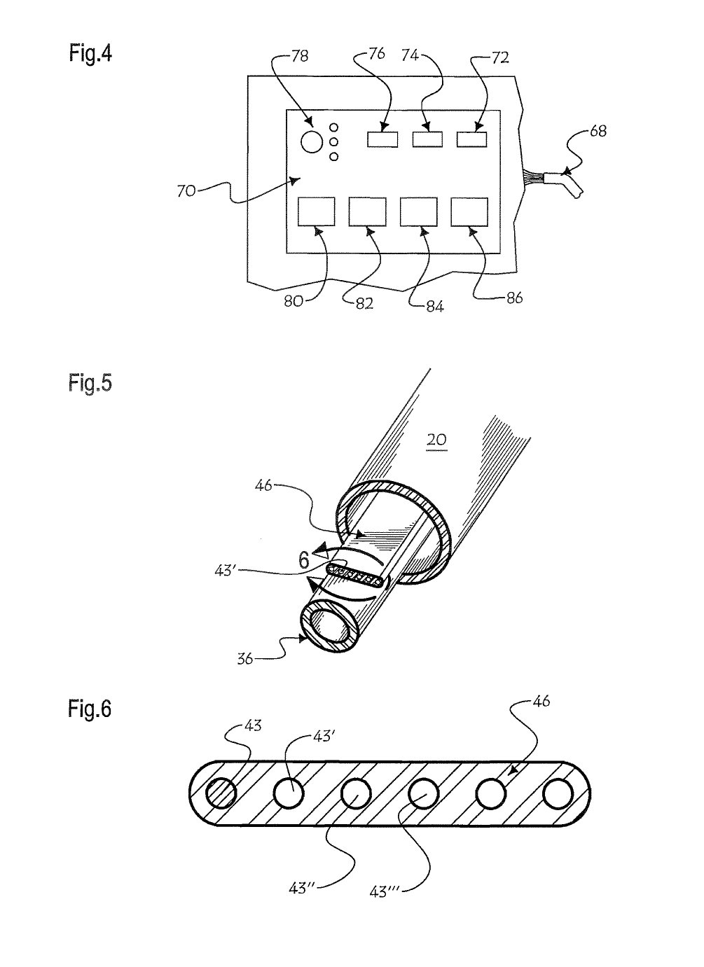

As shown in FIGS. 3 and 5, bladder 30 is pneumatically coupled to a pneumatically circuitry located within the casing 22 by an outer pneumatic line 36 protectively enclosed within the sleeve 20. The outer pneumatic line 36 extends integrally into an inner pneumatic line 38 protectively enclosed within the casing 22. An inner pneumatic line 38 is pneumatically coupled to a pneumatic compressor 40 through a conventional pressure regulator 42 having a built in automatic shut off function and a conventional pneumatic distributor 44 typically having three way two position functions so as to allow for selective inflation and deflation of the bladder 30.

Referring to FIGS. 5 to 9, the sleeve 20 also protectively encloses a contact sleeve 46 enclosing at least one pair of wires 43 and 43′, where one is negative and the other positive, and preferably two pairs of wires 43, 43′, and 43″, 43′″ for redundancy purposes, to be used with a corresponding number of moisture sensors 48. When the moisture level is high enough, the two pairs of electric wires 43, 43′, . . . will start conducting electric current. By moisture level, it is meant a gazeous moisture level, or a liquid moisture level, depending on the type of fluid circulating in channel 13. The wires 43″, 43′″, 43″″ and 43′″″ could use a different type of sensor depending on the type of fluid that needs to be detected, for example a two wire methane sensor could be combined with the existing moisture sensor 43 and 43′.

These electrical sensors will be of the type working at a low level of voltage, for example at the 0.3 volt and 0.1 Ampere range. The moisture sensors 48 are mounted about an intermediate section 34 of inflatable bladder 30, forming the electrical ends of wires 43, 43′, 43″, 43′″. Sensors 48 should preferably be covered by a non corrodible fluid proof conducting alloy. The moisture sensors 48 are preferably welded to the bladder 30 by a conventional sonic welding method or any other suitable method, so that these wire portions 43A, 43B become integral to and concealed by the wall of inflatable bladder 30 about bladder portion 34A. Only the end moisture sensor tips 48, 48′, 48″, 48′″, project freely through the intermediate wall of bladder 30, at a peripheral intermediate location of bladder 30 opposite outer end 34 of bladder 30.

Returning to FIG. 3, wires 43, 43′, . . . extend internally into an internal contacting sleeve section 50 protectively enclosed within the casing 22. The wires 43, . . . are electrically coupled to both a water sensor unit 52 and a programmable central processing unit 54. CPU 54 preferably takes the form of an electronic card. The electronic card 54 is electrically coupled through an internal connecting wire 56 to a relay component 58. An alarm means preferably of the audible piezo type 60 is further operationally mounted within the casing 22 to CPU 54.

The power to the components within the casing 22 is provided by a battery type component 62 being chargeable through a battery charger and converter component 64 preferably of the 120 volt/12 volt DC type. A transformer is adapted to be plugged into a conventional external mains electrical wall outlet through the use of a conventional male plug 66.

An outlet cable 68 is electrically coupled to the relay 58 at a proximal end thereof and at a distal end thereof to a display panel 70 (FIG. 4) mounted on the cover of the casing 22. The display panel 70 preferably includes a first display area 72 for providing visual cue as to the inflation status of the bladder 30, a second display area 74 providing visual cue information on the moisture detection status, a third visual display area 76 for providing visual cue as to the working status of the system as whole, and a fourth display area 78 adapted to provide visual cue indication preferably with a three color code as to the condition of both the battery component 62 and charger component thereof.

A first control button 80 is provided for allowing reset of the internal clock conventionally integral to the CPU 54, a second button control 82 is provided for setting of the internal clock, a third control button 84 is provided for manual testing of the system; while a fourth control button 86 is provided for stopping the audible alarm.

It should be understood that various modifications can be made to the control panel 70 without departing from the scope of the present invention and that the herein above description only refers to an example of such display panel 70.

In use, the moisture sensors 48 are adapted to sense moisture and/or detect by physical engagement with a liquid inside sewer conduit 14 a preset level and, once a moisture upper threshold level or liquid detection has been reached, to activate the air compressor 40 so as to inflate the bladder 30.

The central processing unit 54 preferably has a built in self test feature that periodically measures the conductivity of the moisture sensor 48, and/or could activate the compressor 40, so as to ensure that the latter maintains a predetermined pressure inside the bladder 30. The self test also preferably includes monitoring of the battery 62 and of the battery charger 64. The self test makes sure that the battery 62 is sufficiently charged to allow the full deployment of the inflatable bladder 30 in case there is a mains electrical input power blackout.

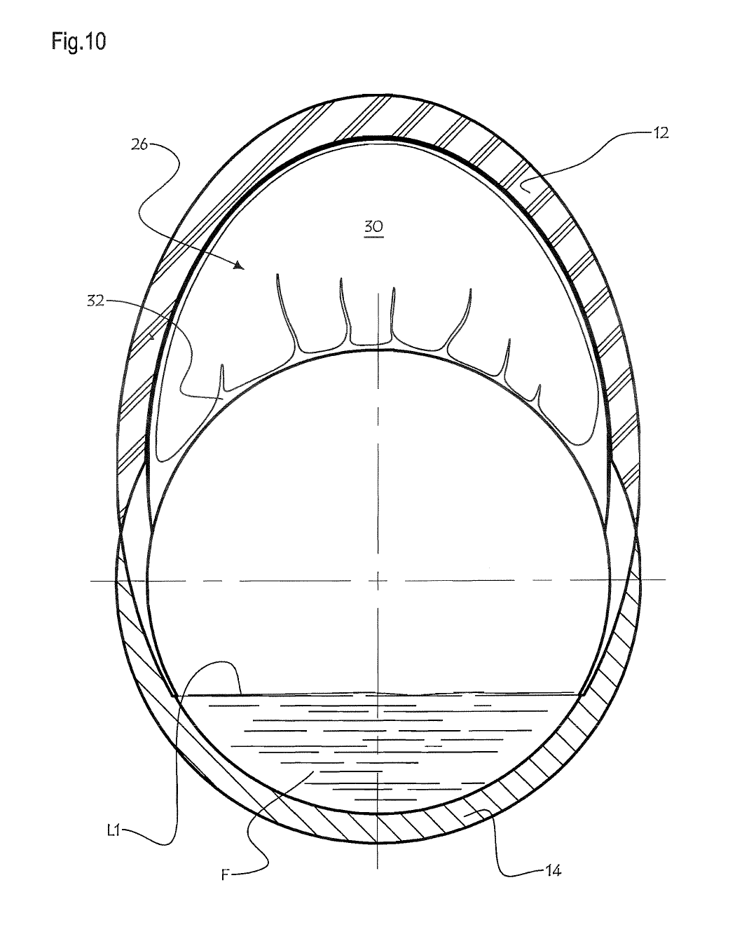

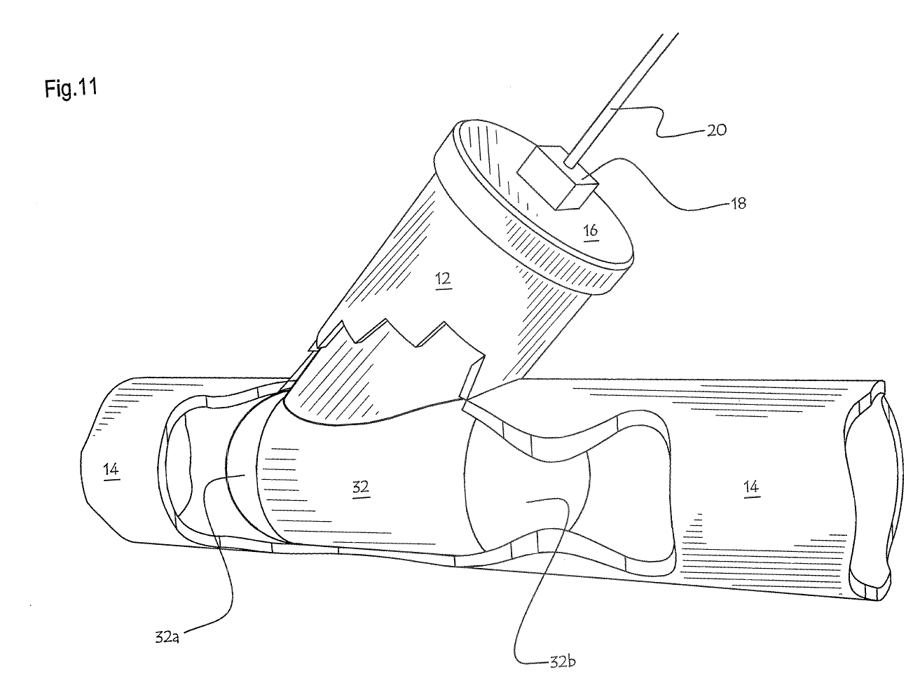

Preferably and as illustrated in FIGS. 10 and 11, a toroidal shape of the section 32 of the inflatable bladder 30 releasably sealing the sewer duct 14, assists in hydrodynamic fluid management. Preferably, the opposite long axis ends of toroidal bladder 30 each forms convex half spheres 32A, 32B, for optimal hydrodynamic fluid flow management.

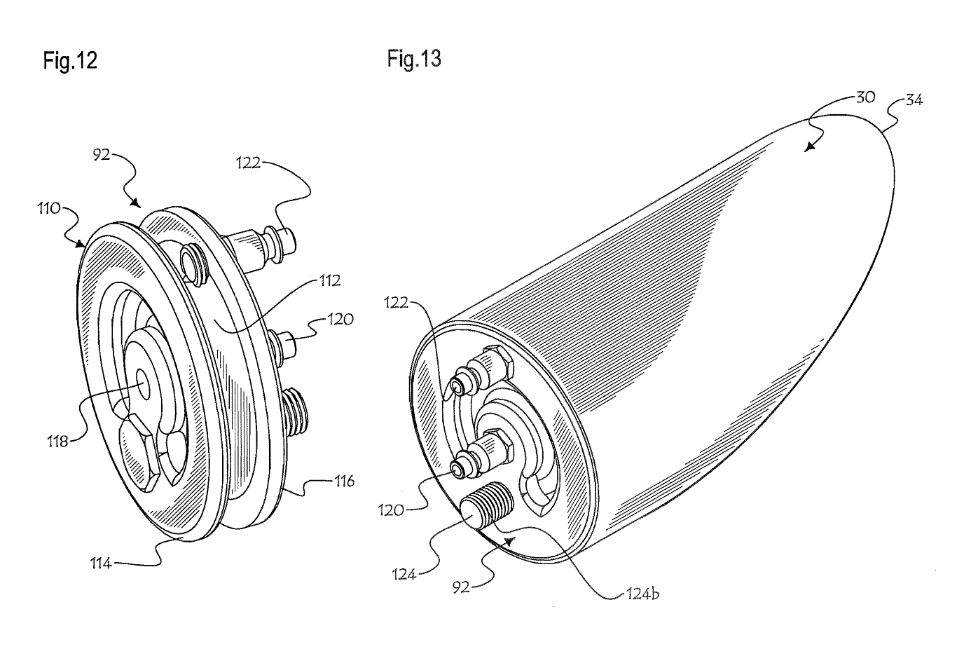

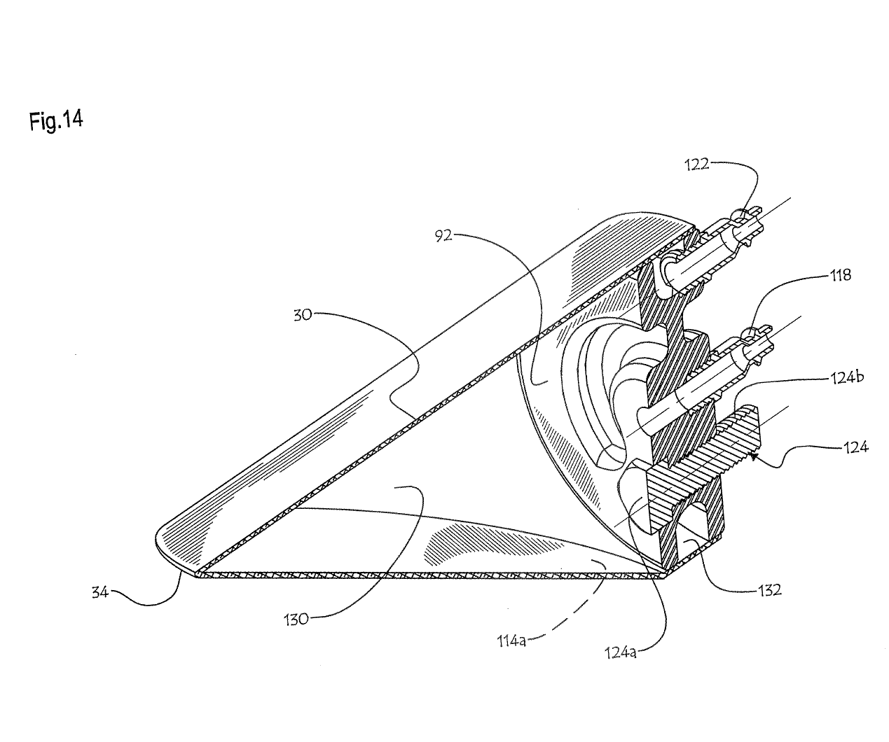

Preferably and as illustrated in FIG. 12 and 13, to facilitate handling of bladder 32, there is provided a discoid support system 92 which is installed transversely inside clean-out duct 12 at the inner end thereof opposite outer closure cap 16. As suggested by arrows 25-25 in FIG. 1, the discoid support system 92 illustrated in FIG. 12 from this perspective of FIG. 1 is spacedly proximate to the main conduct 14. Access to the free top face of discoid support system 92 is easily achieved simply by removing screw cap 16, and by an operator reaching out with his aim through the clean-out duct 12 for maintenance thereof. Inflatable bladder 30 peripherally abuts against and is fixedly mounted to the under face of discoid support system 92. Discoid support system 92 with two facing half moon holes 96, 98 comprising there between a hang screw rod 100 for positioning the discoid support system inside the clean-out duct 12. An air valve 36 is provided on disk 92 to inflate the inflatable bladder 30 in inflated configuration. An air valve system anchor 93 proximate valve 36 assists in the positioning of the present discoid support system. The sensor cable connectors 46 (see FIG. 6) are inside a sheathed anti-corrosive cable that reaches the sensors 43, 43′ . . . that are inside the inflatable bladder 30 at its extremity. The present discoid support system 92 is solid, light weight, and doesn't require any measurements for its installation, since a sound cue, for example a “click” sound, is felt thru the installation rod that reveals it has reached its operational set position in the clean-out duct 12, see FIG. 12. This sound cue comes from the shape of the inflatable bladder 30 in inflated configuration. It is easy to remove the discoid support system from its set position inside the clean-out duct 12 by first pulling the clips of power cable protection 95 to unfix and upwardly pullback the discoid support system.

The present invention provides an improved fluid backup preventing system. Advantages of the present invention include the fact that the system in accordance with the present invention may be readily adapted to existing sewer conduits without the need for special tooling, manual dexterity or other expensive commodities.

Also, the present invention provides a built in sensing means for actuating the valve in predetermined conditions. Furthermore, the present invention provides a system having a self checking feature so as to improve overall reliability.

Also, the present invention uses a duct sealing means that is deformable so as to provide an efficient seal even in situations wherein the sewer conduit is warped or otherwise damaged.

Furthermore, the present invention provides a built in audible warning means for alerting the dwelling occupants of the flood threatening situation.

1. An apparatus for continuously controlling fluid flow in a conduit, comprising:
a) sensor means, for detecting the level of fluid in this conduit;
b) conduit sealing means, for releasably sealing in fluid tight fashion a section of this conduit;
c) main power means, for actuating said sealing means; and
d) control means, sensitive to said sensors means and actuating said main power means responsively to a conduit fluid level reaching beyond a threshold value;
wherein the performance of said control means is independent of the speed of the fluid flow in the conduit.

2. The apparatus of claim 1,
wherein said control means further being sensitive to the deactivation of said main power means, and further including power backup means, whereupon said control means automatically activating said conduit sealing means independently of fluid level in the conduit when said main power means becomes deactivated.

3. The apparatus of claim 1,
wherein said conduit sealing means includes an inflatable bladder for mounting into the conduit section, and further including inflating means for inflating the bladder between a deflated inoperative condition and an operative inflated condition for sealingly closing the conduit section.

4. An apparatus as in claim 3,
wherein said inflatable bladder has in its operative inflated condition a portion of toroidal shape for sealingly engaging the conduit section.

5. An apparatus as in claim 3,
wherein said bladder is elongated with two opposite end portions each forming a convex half sphere.

6. An apparatus as in claim 3,
wherein said sensors means includes at least one pair of positive and negative electrical cables, said cables extending between said control means and said bladder, and moisture sensors mounted at the end of said cables located about said bladder.

7. The apparatus of claim 6,
wherein said moisture sensors are covered by non corrodible fluid proof conducting alloy material, and uses electrical conductivity measures for determining the fluid level in the conduit.

8. An apparatus as in claim 6,
wherein said sensor means consists of two pairs of said electrical cables.

9. The apparatus of claim 6,
wherein said control means further includes a self test function for at least one of
said moisture sensors conductivity; and
said power backup means,
that checks at predefined regular time intervals if said conduit sealing means is operative, and further including alarm means issuing an alarm detectable by the apparatus user upon said control means detecting that said power backup means has become inoperative.

10. A method for operating an apparatus for continuously controlling fluid flow in a conduit, the apparatus of the type comprising sensor means for detecting levels of fluid in this conduit, conduit sealing means for releasably sealing in fluid tight fashion a section of this conduit, main power means for actuating said sealing means, and control means, sensitive to said sensors means and actuating said main power means responsively to a conduit fluid level reaching beyond a threshold value so that the performance of said control means is independent of the speed of the fluid flow in the conduit; wherein the method comprises the following steps:
a) said sensor means sensing a fluid level beyond said threshold value;
b) said control means analysing data coming from the sensors means; and
c) said control means actuating said conduit sealing means responsively to said data.

11. A method as in claim 10,
further including the following steps:
d) having said sensor means detecting fluid level returning to condition short of said threshold level;
e) said control means analysing this latter data from said sensors means; and
f) said control means deactuating said main power means responsively to the latter data.

12. An apparatus as in claim 1,
in combination with a sewer conduit for fitting to a dwelling, said conduit having a clean-out duct mounted transversely thereto and opening into said sewer conduit.

13. The combination of claim 11,
wherein said clean-out duct defines an annular recess fully clearing said channel, said conduit sealing means including an inflatable bladder mounted into said annular recess, and inflating means for inflating the bladder, said bladder when in an inoperative condition remaining fully inside said annular recess and fully clearing said channel to prevent fluid flow turbulence in the conduit when deflated, and when in an operative inflated condition further extending radially into said channel and fully sealingly closing said channel.

14. A method for installing and releasably locking a valve apparatus inside a clean-out duct of a sewer conduit, the valve apparatus for continuously controlling fluid flow in the conduit, the apparatus including: a) sensor means, for detecting the level of fluid in this conduit; b) conduit sealing means, for releasably sealing in fluid tight fashion a section of this conduit; c) main power means, for actuating said sealing means; and d) control means, sensitive to said sensors means and actuating said main power means responsively to a conduit fluid level reaching beyond a threshold value; wherein the performance of said control means is independent of the speed of the fluid flow in the conduit, the apparatus further including a discoid support member releasably mounted inside the clean-out duct, a hang screw rod assisting in the positioning of said discoid support system in said clean-out duct, said sealing means being an inflatable bladder, said inflatable bladder in deflated configuration movable to a set position inside the clean-out duct, and further including retaining clips to prevent accidental release of said apparatus from its said set position, wherein said method comprises the following steps:
a) said hang screw rod moving the said apparatus inside said clean-out duct; and
b) said inflatable bladder in deflated configuration emitting a sound cue emitted through said rod, indicating said deflated bladder has reached its said set position inside the clean-out duct.

15. A method as in claim 14,
wherein said sensor means includes power cables and, upon release of said valve apparatus being required, further including the following step:
c) pulling out said apparatus from said fixed position in said clean-out duct, by upwardly pulling said power cables.
